(19) United States
(12) Patent Application Publication
(10) Pub. No.: US 2011/0310449 A1
(43) Pub. Date: Dec. 22, 2011

(54) METHOD FOR GENERATING 3D VIDEO COMPUTER-GENERATED HOLOGRAM USING LOOK-UP TABLE AND TEMPORAL REDUNDANCY AND APPARATUS THEREOF

(75) Inventors: Eun-Soo Kim, Seoul (KR); Seung-Cheol Kim, Seoul (KR)

(73) Assignees: Eun-Soo Kim, Seoul (KR); Kwangwoon University Research Institute for Industry Cooperation, Seoul (KR); Seung-Cheol Kim, Seoul (KR)

(21) Appl. No.: 12/817,841

(22) Filed: Jun. 17, 2010

(51) Int. Cl. G03H 1/08

(52) U.S. Cl. 359/9

(57) ABSTRACT

A method of computing CGH using look-up table and temporal redundancy and an apparatus thereof are disclosed. The apparatus includes an extracting unit, which extracts a brightness image and a depth image from a target frame of 3D video, a comparing unit, which extracts a change point that is different from a point of the target frame after comparing the brightness image and the depth image of the target frame to a brightness image and a depth image of a previous frame, a hologram computing unit, which computes hologram information by differentiating hologram computing methods using hologram patterns depending on whether a ratio between the number of the change points and the number of the entire frame points is equal to or greater than a predetermined critical value, and a storing unit, which stores the brightness image and the depth image of the target image and the hologram information.

### BACKGROUND

1. Technical Field

The present invention is related to a method of computing hologram, more specifically to a method of computing 3D video computer-generated hologram using a look-up table and temporal redundancy, and an apparatus thereof.

2. Description of the Related Art

Studies are underway to develop 3-dimensional images and image playing back technologies, and it is expected that a next generation display as a real-like image media that can increase the level of visual information higher is about to be developed. Moreover, 3-dimensional images are real-like and more natural than 2-dimensional images, and thus there has been an increasing demand for 3-dimensional images.

Among these 3-dimensional image technologies, holography is a technique that allows an observer to view a virtual 3-dimensional image when a recorded image (hologram) is viewed by a particular distance from the front surface of the recorded image.

The holographic method allows a hologram manufactured by a laser to appear three dimensional viewed by human eyes without any special observation devices. Accordingly, the holographic method is excellent in 3-dimensionality and has been regarded as one of the most attractive approaches for creating the most authentic illusion of observing volumetric objects without human fatigue.

So far, some approaches for generation of digital hologram patterns have been suggested. One of them is the ray-tracing method, which is commonly used to calculate diffraction of light when calculating a hologram pattern. In this method, a target object is regarded as a set of points, and hologram patterns for all points of the target object is calculated and added together. However, this method suffers from the computational complexity because it requires one-by-one calculation of the fringe pattern per image point per hologram sample, making it difficult for real-time playing back.

To overcome this problem, a look-up table (LUT) method that allows a real-time processing was proposed. In this method, all fringe patterns corresponding to point source contributions from each of the possible locations in an image volume are precomputed and stored in the LUT. Nevertheless, this method also involves a great number of fringes as the object becomes bigger, and thus the look-up table becomes too big.

Proposed to solve these problems is a novel look-up table (N-LUT, which is a new type of loop-up table) method that can dramatically reduce the memory capacity of a look-up table while maintaining the high-speed computing speed, like the conventional look-up table method. However, in this method, a great amount of data needs to be processed in order to be employed in video images, making it difficult for practical application.

### SUMMARY

The present invention provides a method for generating 3-dimensional video computer generated hologram using a look-up table and temporal redundancy that allows real-time playing back for video holograms, and an apparatus thereof.

Other problems that the present invention solves will become more apparent through the following embodiments described below.

An aspect of the present invention provides a 3D video hologram computing apparatus. The apparatus in accordance with an embodiment of the present invention can include an extracting unit, which extracts a brightness image and a depth image from a target frame of a 3D video, a comparing unit, which extracts a change point that is different from a point of the target frame after comparing the brightness image and the depth image of the target frame to a brightness image and a depth image of a previous frame, a hologram computing unit, which computes hologram information by differentiating hologram computing methods using hologram patterns depending on whether a ratio between the number of the change points and the number of the entire frame points is equal to or greater than a predetermined critical value, and a storing unit, which stores the brightness image and the depth image of the target image and the hologram information. Here, the target frame is a base frame of an image about to be computed, and the previous frame is a frame that is previous to the target frame.

Another aspect of the present invention provides a method of computing a 3D video hologram. The method in accordance with an embodiment of the present invention can include extracting a brightness image and a depth image from a target frame of a 3D video, extracting a change point that is different from a point of the target frame after comparing the brightness image and the depth image of the target frame to a brightness image and a depth image of a previous frame, computing hologram information by differentiating hologram computing methods using hologram patterns depending on whether a ratio between the number of the change points and the number of the entire frame points is equal to or greater than a predetermined critical value, and storing the brightness image and the depth image of the target image and the hologram information. Here, the target frame is a base frame of an image about to be computed, and the previous frame is a frame that is previous to the target frame.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 shows a method of obtaining 3-dimensional information using holography in accordance with an embodiment of the present invention.

FIG. 2 shows a hologram computing apparatus using look-up table and temporal redundancy in accordance with an embodiment of the present invention.

FIG. 3 shows a hologram computing unit in accordance with an embodiment of the present invention.

FIG. 4 is a process of computing a hologram by using look-up table and temporal redundancy in accordance with an embodiment of the present invention.

FIG. 5 is a diagram illustrating 3D input images and 3D depth images to which a method of computing a 3D video hologram using look-up table and temporal redundancy is applied in accordance with an embodiment of the present invention.

FIG. 6 is a diagram illustrating change points of brightness images and depth images in accordance with an embodiment of the present invention.

FIG. 7 is a diagram illustrating images that are digitally reconstructed after the images shown in FIG. 6 are processed to make holograms by using a method of computing a hologram in accordance with an embodiment of the present invention.

FIG. 8 is a graph illustrating the number of points computed for each frame of each 3D video according to a method of computing a hologram in accordance with an embodiment of the present invention and according to the related art.

FIG. 9 is a graph illustrating computation time consumed for computing a hologram for each frame of each 3D video according to a method of computing a hologram in accordance with an embodiment of the present invention and according to the related art.

FIG. 10 is a graph illustrating computation time consumed for computing a hologram for each point of each 3D video according to a method of computing a hologram in accordance with an embodiment of the present invention and according to the related art.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Certain embodiments of the present invention will be described below in detail with reference to the accompanying drawings. Those components that are the same or are in correspondence are rendered the same reference numeral regardless of the figure number, and redundant descriptions are omitted. Before describing certain embodiments of the present invention, a general principle and a system for obtaining 3-dimensional information using holography will be first described below.

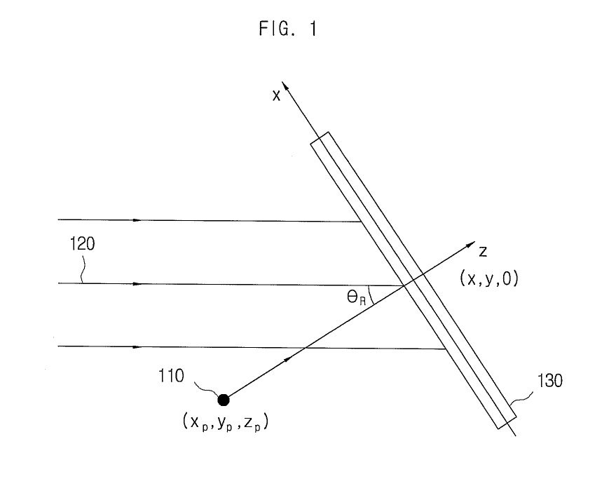

FIG. 1 shows a method of obtaining 3-dimensional information using holography in accordance with an embodiment of the present invention.

In holography, a simple hologram can be made by superimposing two waves from the same laser beam from a laser. One hits a screen normally, and the other one hits a target object. Here, the beam hitting the screen normally is referred to as a reference wave (the reference beam 120), and the beam hitting the target object is referred to as an object wave.

Since the object wave is a beam that reflects from the surface of the target object, the relative phase between the two waves varies, depending on the distance between the surface of the object and the screen. Here, the reference wave, which is not deformed, and the object wave interfere with each other to form an interference pattern, and then the interference pattern is stored in the screen. The recorded film, in which the interference pattern is stored, is referred to as a hologram.

A computer generated hologram (hereinafter, referred to as CGH) pattern is digitally computed by the coordinate (x, y, z) and the intensity value I of pixels. The CGH is used in obtaining a 3-dimensional hologram image. The geometry for computing the Fresnel hologram of an object image is shown in FIG. 1. Although the following description focuses on the CGH, it shall be apparent that the present invention is not restricted to this example.

The hologram is located at an x-y plane 130. Here, the location coordinate of a pth point of the object is specified by a point (xₚ, yₚ, zₚ) 110, and each object point is assumed to have an associated real-valued magnitude and phase of aₚ and Φₚ, respectively. These are used for the following equation by a computer.

In the hologram, a complex amplitude O(x, y) can be obtained by the superposition of the object wave, as expressed by the following equation 1.

$$O ( x , y ) = {\sum }_{p = 1}^{N} \frac{{a}_{p}}{{r}_{p}} exp [ j ( {kr}_{p} + {φ}_{p} ) ] \qquad ( 1 )$$

Here, p is points (object points) constituting an object, and N is the number of object points. aₚ is the magnitude of the object wave, and k is a frequency vector and defined as k=2 π/λ, in which λ is a wavelength of light in a free space. rₚ is a sloping distance between the pth point of the object and the point on the hologram plane of (x, y, 0) and is defined by the following equation 2.

rₚ=\sqrt{(x−xₚ)²+(y−yₚ)²+zₚ²} (2)

A complex amplitude R(x, y) of the reference wave, which is a plane wave, is expressed by the following equation 3.

R(x,y)=a_{R}exp[j(kx sin θ_{R})] (3)

Here, a_{R} and θ_{R} are the magnitude of the reference beam and the incident angle of the reference beam, respectively. The overall grid intensity I(x, y) of the hologram plane is an interference pattern between the object beam O(x, y) and the reference beam R(x, y) and is expressed by the following equation 4.

$$\begin{matrix}I ( x , y ) = {\vert R ( x , y ) + O ( x , y ) \vert}^{2} \\ = {\vert R ( x , y ) \vert}^{2} + {\vert O ( x , y ) \vert}^{2} + \\ 2 \vert R ( x , y ) \vert \vert O ( x , y ) \vert cos [ {kr}_{p} + kx sin {θ}_{R} + {φ}_{p} ]\end{matrix} \qquad ( 4 )$$

In the equation 4, a first part |R(x,y)|² is the intensity of the reference wave, and a second part |O(x,y)|² is the intensity of the object wave. A third part 2|R(x,y)∥O(x,y)|cos [krₚ+kx sin θ_{R}+φₚ] is the interference pattern between the object wave and the reference wave that partially includes hologram information, and includes phase information in accordance with the spatial location of the object wave.

In the following equation 5, the hologram information is included in the third part only, and thus the hologram information I(x, y) can be expressed as follows.

$$I ( x , y ) = 2 {\sum }_{p = 1}^{N} \frac{{a}_{p}}{{r}_{p}} cos ( {kr}_{p} + kx sin {θ}_{R} + {φ}_{p} ) \qquad ( 5 )$$

Specifically, in the conventional beam tracing method, a hologram pattern can be computed by the equation 5. Nevertheless, as it can be seen in the equation 5, the equation for computing the hologram pattern is very complicated so that it is quite difficult to compute the hologram pattern in real time.

Proposed to solve the above problem is a method using a look-up table in which a fringe pattern that can express the entire points inside a particular object is pre-made and stored in the look-up table, and a hologram is computed by bring each fringe pattern in accordance with a 3-dimensional image to be computed.

Before describing the components of the present invention, a preconditioned aspect of certain embodiments of the present invention is as follows. Generally, an image space is not separable. However, since the human being's optical system is limited in its ability, the resolution can be selected without compromising the image quality. Here, the degree of separation is small enough not to be recognized by the eyes of a person so that two successively formed points can be recognized as if the two points were not separated from each other. For example, a human recognizes two points having a gap of 3 milliradians as one single point. Accordingly, when an image is viewed from a distance of 500 mm, two points having a gap of 150 microns or less (500 mm×0.003=150 microns) can be recognized as one single point. In an embodiment of the present invention, the degree of horizontal and vertical separation will be set to 150 microns.

In the method using the look-up table, a fringe pattern has to be precomputed. The fringe pattern T(x, y; xₚ, yₚ, zₚ) is reference brightness that can express each point and can be expressed by the following equation 6 by using the equation 5.

$$T ( x , y ; {x}_{p} , {y}_{p} , {z}_{p} ) ≡ \frac{1}{{r}_{p}} cos [ {kr}_{p} + kx sin {θ}_{R} + {φ}_{p} ] \qquad ( 6 )$$

Here, rₚ, which is expressed by the equation 2, is the distance between a pth point and the point (x, y, 0).

In this method, a hologram is not computed by computing the fringe pattern of each point whenever it is required, like the equation 5, but the hologram is computed by using the pre-made look-up table, which is a set of fringe patterns with respect to each point (xₚ, yₚ, zₚ). Accordingly, in the look-up table method, the hologram information I(x, y) is finally provided as the following equation 7. Here, N is the number of object points.

$$I ( x , y ) = {\sum }_{p = 1}^{N} {a}_{p} T ( x , y ; {x}_{p} , {y}_{p} , {z}_{p} ) \qquad ( 7 )$$

The method using the look-up table (LUT) has brought a tremendous increase in speed by using the pre-computed fringe patterns with respect to all possible points of an object image when holograms are combined. Nevertheless, the biggest drawback of this method is that the amount of pre-computed fringe patterns is too many so that the memory of the LUT, which stores the pre-computed fringe patterns, will increase dramatically. For example, if it is assumed that, in the LUT method, an object space is 100 (width)×100 (height)×100 (depth), and the memory capacity of each fringe pattern is 1 MB, the memory capacity of the entire look-up table may require 1 MB×100×100×100=1 TB.

Proposed to solve these problems is N-LUT, which is a new type of loop-up table, that can significantly reduce the memory capacity of the look-up table while maintaining the high-speed computing speed, like the conventional look-up table method. With this, a high-speed digital holographic calculation method using the N-LUT is also proposed. Specifically, in the N-LUT method, fringe patterns with respect to the depth of an object are computed and stored only. If a depth direction of the object is determined, the fringe patterns of the object points exist on that particular surface can be computed and added together to compute a hologram pattern on the particular planar surface by moving the precomputed and stored fringe patterns of that particular depth from the left to its opposite direction up to each object point. In the same way, hologram patterns for the entire object can be computed by computing and adding all the holograms together in all depth planes. Accordingly, while the conventional LUT method requires the fringe patterns with respect to all directions, i.e., the width, the height, and the depth, of the object points to be stored, the proposed N-LUT method requires the fringe patterns with respect to the depth of the object points to be prestored only, thus dramatically reducing the required capacity of memory.

In the N-LUT method, fringe patterns are needed to be precomputed. That is, each fringe pattern T(x, y; zₚ) becomes a Fresnel zone plate having reference intensity with respect to each depth, and can be expressed by the following equation 8.

$$T ( x , y ; {z}_{p} ) ≡ \frac{1}{{r}_{p}} cos [ {kr}_{p} + kx sin {θ}_{R} + {φ}_{p} ] \qquad ( 8 )$$

Here, rₚ, which is expressed by the equation 2, is the distance between a pth point and the point (x, y, 0). In the newly proposed N-LUT method, fringe patterns with respect to the depth of an object are computed and stored only. If a depth direction of the object is determined, the fringe patterns of the object points exist on that particular surface can be computed and added together to compute a hologram pattern on the particular planar surface by moving the precomputed and stored fringe patterns of that particular depth up to each object point. In the same way, hologram patterns for the entire object can be computed by computing and adding all the holograms together in all depth planes. Accordingly, in the LUT method, the hologram information I(x, y) can be expressed by the following equation 9.

$${I}_{n} ( x , y ) = {\sum }_{p = 1}^{N} {a}_{p} T ( x - {x}_{p} , y - {y}_{p} ; {z}_{p} ) \qquad ( 9 )$$

By using the N-LUT method, a hologram pattern can be computed and restored at high-speed. Nevertheless, the method has a number of points to be computed if an image to be computed has an increase in resolution, thus increasing the computational complexity.

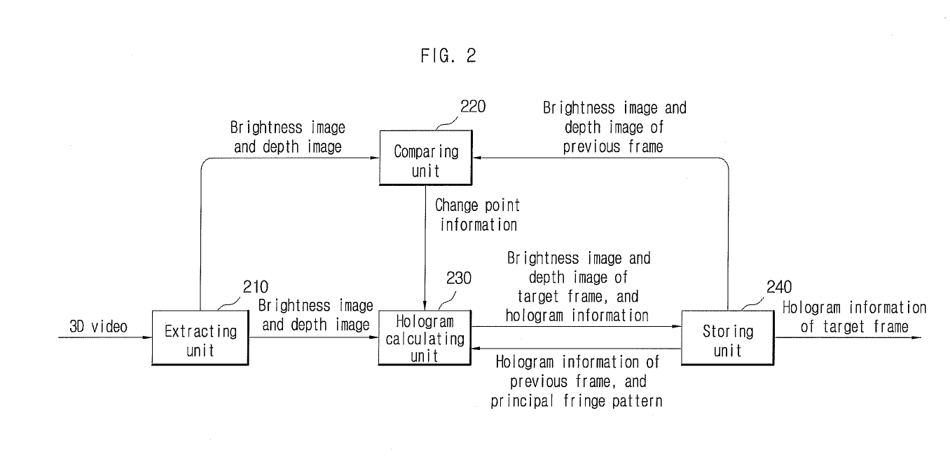

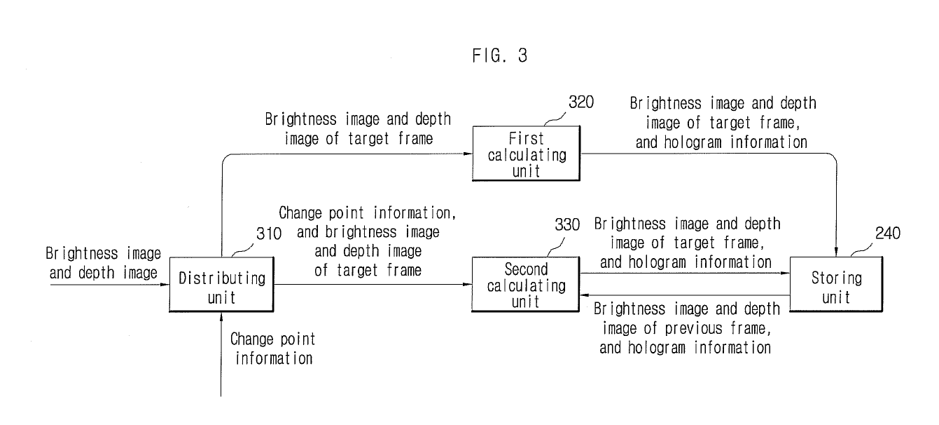

Generally, a 3D video is constituted by 30 frames per second. That is, the gap between two frames is considerably a short period of time, and thus the image difference between the two frames is considerably small. Likewise, in the 3D video, the differences in brightness image and depth image are also small. This is referred to as temporal redundancy of the 3D video. When a hologram is computed by using the temporal redundancy, the computational complexity can be reduced. A hologram computing apparatus using a look-up table and temporal redundancy will be described below with reference to FIGS. 2 and 3.

FIG. 2 shows a hologram computing apparatus using look-up table and temporal redundancy in accordance with an embodiment of the present invention, and FIG. 3 shows a hologram computing unit in accordance with an embodiment of the present invention. Referring to FIG. 2, the hologram computing apparatus in accordance with an embodiment of the present invention is constituted by an extracting unit 210, a comparing unit 220, a hologram computing unit 230 and a storing unit 240.

The extracting unit 210 extracts a brightness image and a depth image from an inputted 3D video. Here, the 3D video is an image of an actual object captured by a 3D camera or a video image extracted by computer graphics.

The extracting unit 210 extracts a brightness image and a depth image from a frame (hereinafter, referred to as a “target frame”), from which a hologram is about to be computed, among the 3d video data. Then, the extracting unit 210 outputs the brightness image and the depth image to the comparing unit 220 and the hologram computing unit 230.

The comparing unit 220 compares each point of the brightness image and the depth image of the target frame to that of the brightness image and the depth image of a frame (hereinafter, referred to as a “previous frame”) that is previous to the target frame and extracts a point (hereinafter, referred to as a “change point”) that is different from the point of the target frame. Then, the comparing unit 220 outputs change point information to the hologram computing unit 230.

The hologram computing unit 230 computes holograms by differentiating hologram computing methods, depending on whether the ratio between the number of the change points and the number of the entire frame points is equal to or greater than the predetermined critical value. The hologram computing unit 230 is constituted by a distributing unit 310, a first computing unit 320 and a second computing unit 330.

The distributing unit 310 determines whether or not the ratio between the number of the change points and the number of the entire frame points is equal to or greater than the predetermined critical value by receiving the change point information from the comparing unit 220 and the brightness image and the depth image of the target object from the extracting unit 210. Then, if the ratio is equal to or greater than the critical value, the distributing unit 310 outputs the brightness image and the depth image of the target object to the first computing unit 320. Also, if the ratio is less than the critical value, the distributing unit 310 outputs the brightness image and the depth image of the target object and the change point information to the second computing unit 330. In one example, the distributing unit 310 computes the ratio between the number of the change points and the number of the entire frame points by identifying the number of the change points from the change point information. Here, the number of the entire frame points can be prestored in the distributing unit 310 or can be computed from the brightness image and the depth image of the target frame, which are inputted from the extracting unit 210. Then, if the computed ratio is equal to or greater than 0.5, the distributing unit 310 outputs the brightness image and the depth image of the target object to the first computing unit 320. Also, if the computed ratio is less than 0.5, the distributing unit 310 outputs the brightness image and the depth image of the target object and the change point information to the second computing unit 330. Although the critical value is set to be 0.5 in this embodiment, it shall be apparent that the distributing unit 310 can randomly set the critical value.

The first computing unit 320 computes hologram information by using the brightness image and the depth image of the target frame, which are inputted from the distributing unit 310, and the N-LUT method, which has been described above. Then, the first computing unit 320 outputs the brightness image and the depth image of the target frame and the hologram information, which is provided in accordance with the equation 9, to the storing unit 240.

The second computing unit 330 receives the brightness image and the depth image of the target frame and the change point information from the distributing unit 310, and receives the brightness image, the depth image and the hologram information of the previous frame by sending a request signal to the storing unit 240. Then, the second computing unit 330 removes the hologram pattern, corresponding to the change point, of the previous frame from the hologram information of the previous frame and inserts the hologram pattern of the target frame. That is, only for a point corresponding to the change point, the second computing unit 330 removes the hologram pattern of the previous frame from the hologram information of the previous frame and inserts the hologram pattern of the target frame. Accordingly, the hologram information I(x, y) can be expressed by the following equation 10.

$${I}_{n} ( x , y ) = {I}_{n - 1} ( x , y ) - {\sum }_{p = 1}^{{N}_{d}} {a}_{{p}_{n - 1}} {U}_{n - 1} ( x - {x}_{p} , y - {y}_{p} ; {z}_{p} ) + {\sum }_{p = 1}^{{N}_{d}} {a}_{{p}_{n}} {U}_{n} ( x - {x}_{p} , y - {y}_{p} ; {z}_{p} ) \qquad ( 10 )$$

Here, Iₙ is the hologram information of an n-th frame, N_{d} is the number of changed points between the previous frame and the current frame, Uₙ(x,y;zₚ) is the fringe pattern of the n-th frame. Here, Uₙ(x,y;zₚ) is the hologram pattern of change point of the n-th frame, and is 0 at points other than the change point. The fringe pattern of the n-th frame can be expressed by the following equation 11.

$${U}_{n} ( x , y ; {z}_{p} ) = \{ \begin{matrix}T ( x , y ; {z}_{p} ) & for changed part \\ 0 & for unchanged part\end{matrix} \qquad ( 11 )$$

Referring to FIG. 2 again, the storing unit 240 stores brightness image, depth image and hologram information. Here, the storing unit 240 outputs information per frame that is needed when the second computing unit 330 computes a hologram, depending on the request signal, and receives and stores the brightness image, the depth image and the hologram information of the target frame from the first computing unit 320 or the second computing unit 330. This information will be used as the information of the previous frame while a hologram corresponding to the next target frame is computed. Also, the storing unit 240 outputs the hologram information of the target frame to an external device. Here, it shall be apparent that the hologram computing unit 230 other than the storing unit 240 can output the hologram information to an external device.

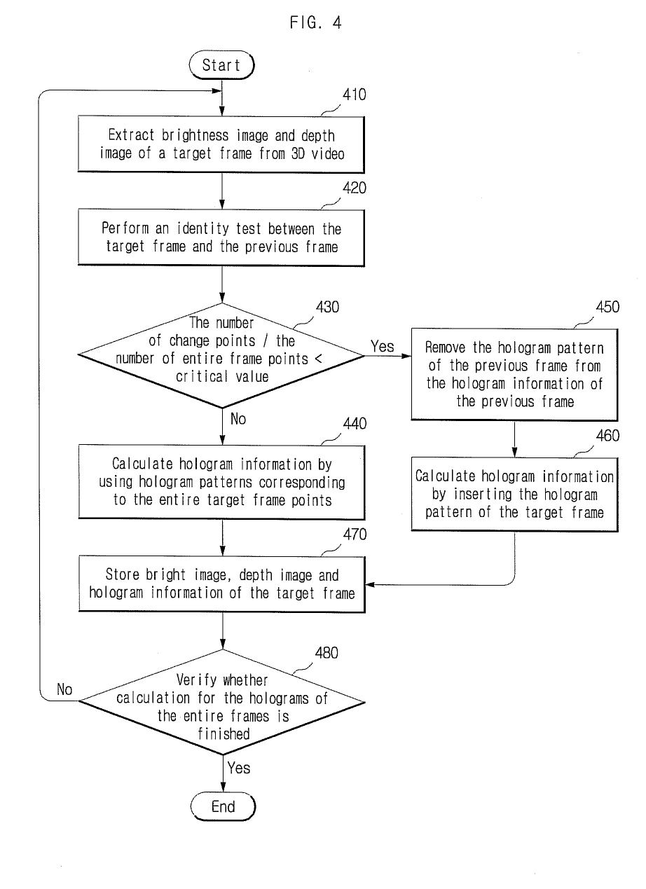

Referring to FIG. 4, the process for computing a hologram of 3D video in accordance with an embodiment of the present invention will be described below. FIG. 4 is a process of computing a hologram by using look-up table and temporal redundancy in accordance with an embodiment of the present invention. For the convenience of description and understanding, the mode units constituting the hologram computing apparatus will be collectively referred to as a “hologram computing apparatus.”

Referring to FIG. 4, in step 410, the hologram computing apparatus sets a target frame from the frames included in a 3D video, and extracts brightness image and depth image o the target frame.

In step 420, the hologram computing apparatus performs an identity test between the target frame and its previous frame. For example, the hologram computing apparatus finds a point that is different in brightness image and depth image among the points of the previous frame corresponding to the points of the target frame, and sets the point as a change point.

In step 430, the hologram computing apparatus determines whether the ratio between the number of the change points and the number of the entire frame points is less than the critical value.

In step 440, if the ratio between the number of the change points and the number of the entire frame points is equal to or greater than the critical value, the hologram computing apparatus computes hologram information by using hologram patterns corresponding to the entire target frame points. Here, the hologram computing apparatus computes the hologram information by using the N-LUT method.

In step 450, if the ratio between the number of the change points and the number of the entire frame points is less than the critical value, the hologram computing apparatus removes the hologram pattern of the previous frame from the hologram information of the previous frame.

In step 460, the hologram computing apparatus computes hologram information by inserting the hologram pattern of the target frame.

In step 470, the hologram computing apparatus stores bright image, depth image and hologram information of the target frame.

In step 480, the hologram computing apparatus verifies whether calculation for the holograms of the whole frames is finished.

If calculation for the holograms of the whole frames is not finished yet, the hologram computing apparatus performs the processes from the step 410.

If calculation for the holograms of the whole frames is finished, the hologram computing apparatus stops the execution.

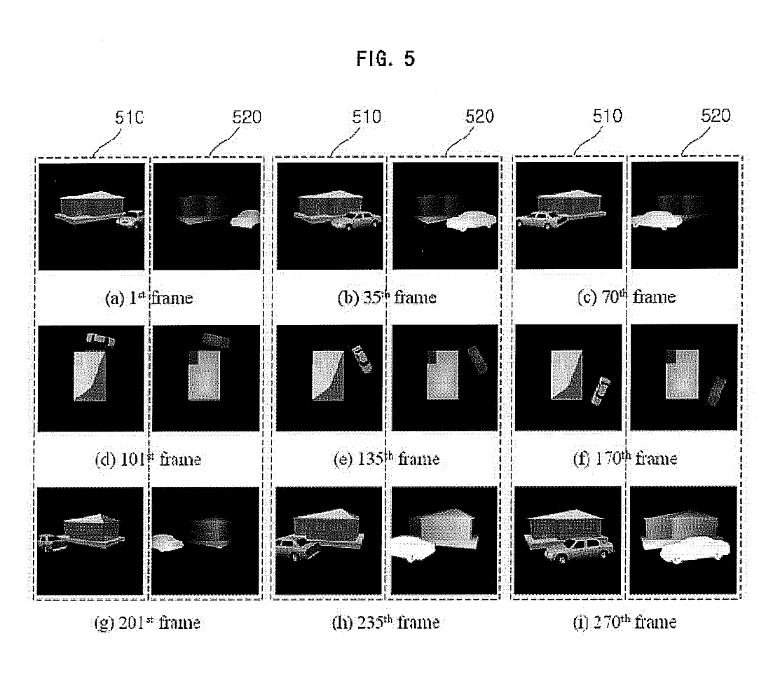

FIG. 5 is a diagram illustrating 3D input images and 3D depth images to which a method of computing a 3D video hologram using look-up table and temporal redundancy is applied in accordance with an embodiment of the present invention. In an embodiment of the present invention, a brightness image 510 is a set of 300 frames. Among them, 100 frames are images illustrating a house and a car turning around the house, 100 frames are images of the house and the car viewed from the top, and 100 frames are images of the house and the car viewed from different viewing angles as the camera moves from one place to another. A depth image 520 is constituted by 300 frames, which are images of the brightness images 510 in accordance with the depth information. Each image has a resolution of 150×150, and the size of a hologram is 500×500.

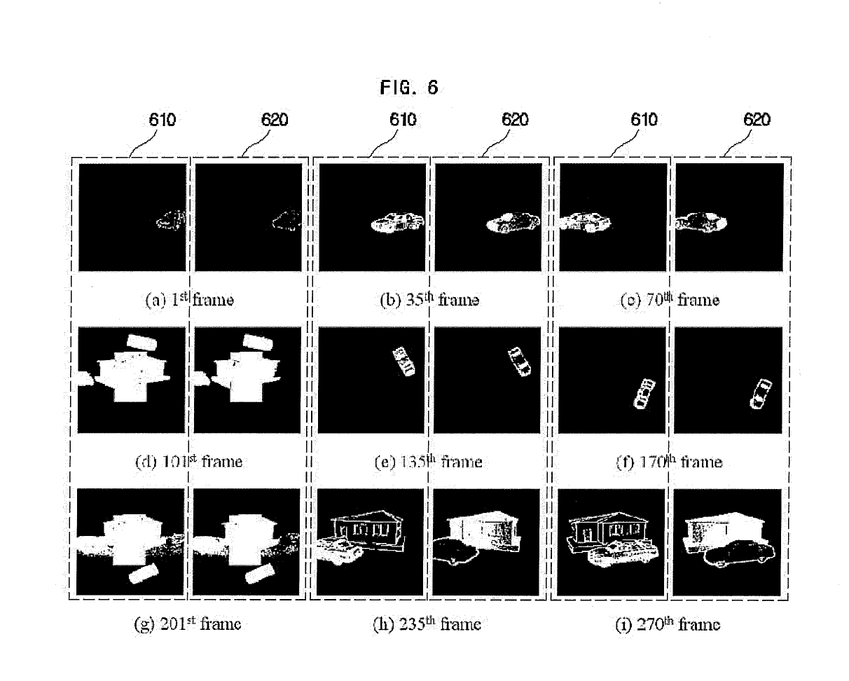

FIG. 6 is a diagram illustrating change points of brightness images and depth images in accordance with an embodiment of the present invention. Referring to brightness images 610 and depth images 620 shown in FIG. 6, it can be seen that there are not many changes between frames, except some areas where a scene rapidly changes as the camera moves quickly.

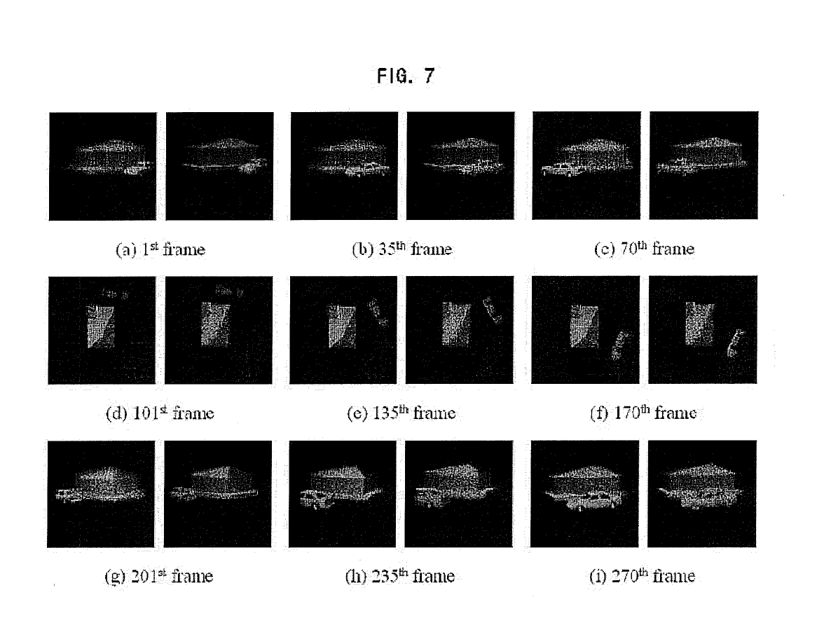

FIG. 7 is a diagram illustrating images that are digitally reconstructed after the images shown in FIG. 6 are processed to make holograms by using a method of computing a hologram in accordance with an embodiment of the present invention. Each image shown in FIG. 7 is reconstructed by focusing on the house and the car, and it can be seen that the images are clearly reconstructed.

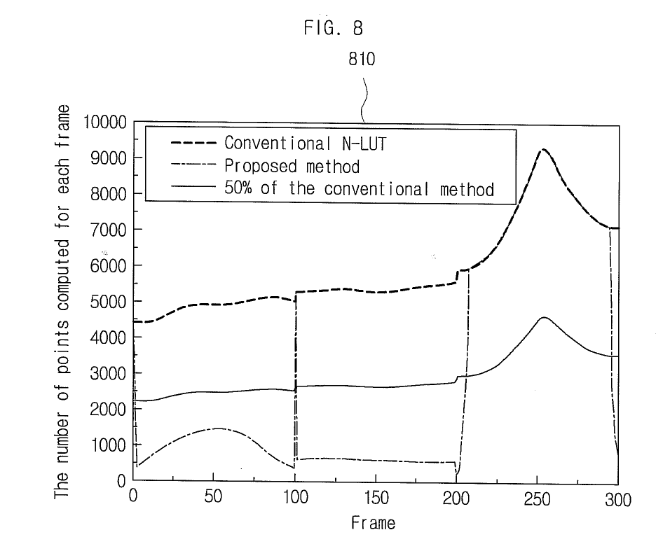

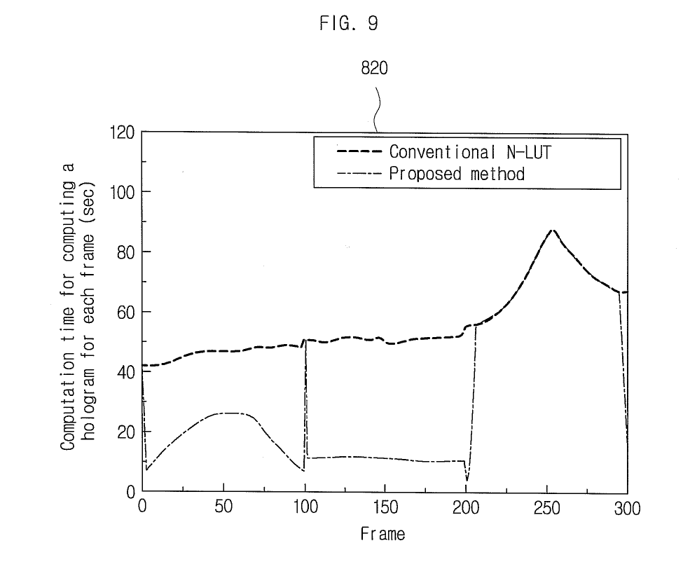

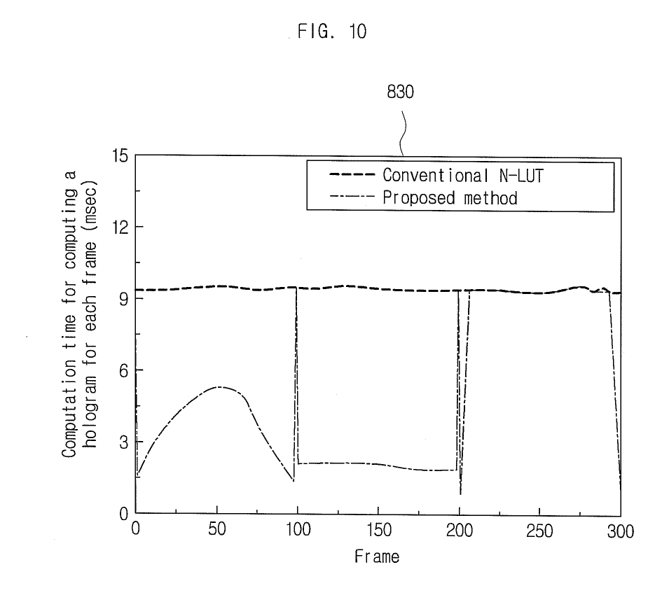

FIG. 8 is a graph 810 illustrating the number of points computed for each frame of each 3D video according to a method of computing a hologram in accordance with an embodiment of the present invention and according to the related art, and FIG. 9 is a graph 820 illustrating computation time consumed for computing a hologram for each frame of each 3D video according to a method of computing a hologram in accordance with an embodiment of the present invention and according to the related art. FIG. 10 is a graph 830 illustrating computation time consumed for computing a hologram for each point of each 3D video according to a method of computing a hologram in accordance with an embodiment of the present invention and according to the related art. Referring to FIGS. 8 to 10, it can be seen that the frame interval between the 200^{th} frame and the 300^{th} frame has almost the same computational complexity according to a method of computing a hologram in accordance with an embodiment of the present invention and according to the related art since the motion of the object is big. Also, as shown in FIGS. 8 to 10, it can be seen that the method of computing a hologram in accordance with an embodiment of the present invention has less computational complexity in the frame interval between the first frame and the 200^{th} frame than the conventional method. Specifically, although the method in accordance with an embodiment of the present invention provides computational complexity similar to the conventional method in a section that has many changes, it can reduce the computational complexity in a section that does not have many changes.

The number of points computed for each frame according to a method of computing a hologram in accordance with an embodiment of the present invention and according to the related art, computation time consumed for computing the entire holograms according to a method of computing a hologram in accordance with an embodiment of the present invention and according to the related art, and computation time consumed for computing a hologram for each point according to a method of computing a hologram in accordance with an embodiment of the present invention and according to the related art are shown in the following table.

| | | Conventional N- | |
|---|---|---|---|
| | | LUT method | Proposed method |
| The number of points to | Part I | 4864 | 1047 |
| be computed for frame | Part II | 5386 | 650 |
| | Part III | 7440 | 6857 |
| Total computation time | Part I | 46.0 | 18.8 |
| consumed for computing | Part II | 50.9 | 11.3 |
| the entire hologram (sec) | Part III | 70.1 | 66.5 |
| Average computation | Part I | 9.5 | 3.9 |
| time for one object point | Part II | 9.5 | 2.1 |
| (ms) | Part III | 9.4 | 8.9 |

The method for computing and reconstructing a 3D video computer-generated hologram using a look-up table and temporal redundancy in accordance with an embodiment of the present invention can be performed by a device, for example, a mobile communication terminal, after the method is stored in a storage medium. Here, the storage medium can be a magnetic or optically readable storage medium, for example, a hard disk, a video tape, CD, VCD and DVD, or a database of a client or sever computer that is built on off-line or on-line.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention.

What is claimed is:

1. A 3D video hologram computing apparatus comprising:
an extracting unit configured to extract a brightness image and a depth image from a target frame of a 3D video;
a comparing unit configured to extract a change point that is different from a point of the target frame after comparing the brightness image and the depth image of the target frame to a brightness image and a depth image of a previous frame;
a hologram computing unit configured to compute hologram information by differentiating hologram computing methods using hologram patterns depending on whether a ratio between the number of the change points and the number of the entire frame points is equal to or greater than a predetermined critical value; and
a storing unit configured to store the brightness image and the depth image of the target image and the hologram information,
wherein the target frame is a base frame of an image about to be computed, and the previous frame is a frame that is previous to the target frame.

2. The apparatus of claim 1, wherein the hologram computing unit comprises:
a first computing unit configured to compute the hologram information by using the hologram patterns corresponding to the entire frame points if the ratio between the number of the change points and the number of the entire frame points is equal to or greater than the predetermined critical value; and
a second computing unit configured to compute the hologram information of the target frame by removing a hologram pattern, corresponding to the change point, of the previous frame from the hologram information of the previous frame and inserting a hologram pattern, corresponding to the change point, of the target frame if the ratio between the number of the change points and the number of the entire frame points is less than the predetermined critical value.

3. The apparatus of claim 2, wherein the critical value is 0.5.

4. The apparatus of claim 2, wherein the hologram pattern is computed by using the following equation,
$$T ( x , y ; {z}_{p} ) ≡ \frac{1}{{r}_{p}} cos [ {kr}_{p} + kx sin {θ}_{R} + {φ}_{p} ]$$
whereas, p is a natural number, T is the hologram pattern, rₚ is a distance between a pth point and a point (x, y, 0), k is defined as k=2 π/λ, in which λ is the free space wavelength of the light, θ_{R} is an angle between a reference beam and an object beam, and Φₚ is a phase value of an object beam of a pth point of the target object.

5. The apparatus of claim 2, wherein the first computing unit computes the hologram information by using the following equation,
$${I}_{n} ( x , y ) = {\sum }_{p = 1}^{N} {a}_{p} T ( x - {x}_{p} , y - {y}_{p} ; {z}_{p} )$$
whereas, Iₙ is the hologram information of an n-th frame, aₚ is an intensity value of the object beam of the pth point of the target object, and N is the number of points of the target object.

6. The apparatus of claim 2, wherein the second computing unit computes the hologram information by using the following equation,
$${I}_{n} ( x , y ) = {I}_{n - 1} ( x , y ) - {\sum }_{p = 1}^{{N}_{d}} {a}_{{p}_{n - 1}} {U}_{n - 1} ( x - {x}_{p} , y - {y}_{p} ; {z}_{p} ) + {\sum }_{p = 1}^{{N}_{d}} {a}_{{p}_{n}} {U}_{n} ( x - {x}_{p} , y - {y}_{p} ; {z}_{p} )$$
whereas, Iₙ is the hologram information of an n-th frame, N_{d} is the number of changed points, and Uₙ is the hologram pattern of change point and 0 at points other than the change point.

7. A method of computing a 3D video hologram, the method comprising:
extracting a brightness image and a depth image from a target frame of a 3D video;
extracting a change point that is different from a point of the target frame after comparing the brightness image and the depth image of the target frame to a brightness image and a depth image of a previous frame;
computing hologram information by differentiating hologram computing methods using hologram patterns depending on whether a ratio between the number of the change points and the number of the entire frame points is equal to or greater than a predetermined critical value; and
storing the brightness image and the depth image of the target image and the hologram information,
wherein the target frame is a base frame of an image about to be computed, and the previous frame is a frame that is previous to the target frame.

8. The method of claim 7, wherein the computing of the hologram information comprises: computing the hologram information by using the hologram patterns corresponding to the entire frame points if the ratio between the number of the change points and the number of the entire frame points is equal to or greater than the predetermined critical value; and
computing the hologram information of the target frame by removing a hologram pattern, corresponding to the change point, of the previous frame from the hologram information of the previous frame and inserting a hologram pattern, corresponding to the change point, of the target frame if the ratio between the number of the change points and the number of the entire frame points is less than the predetermined critical value.

9. The apparatus of claim 8, wherein the critical value is 0.5.

10. The method of claim 8, wherein the hologram pattern is computed by using the following equation,
$$T ( x , y ; {z}_{p} ) ≡ \frac{1}{{r}_{p}} cos [ {kr}_{p} + kx sin {θ}_{R} + {φ}_{p} ]$$
whereas, p is a natural number, T is the hologram pattern, rₚ is a distance between a pth point and a point (x, y, 0), k is defined as k=2 π/λ, in which λ is the free space wavelength of the light, θ_{R} is an angle between a reference beam and an object beam, and Φₚ is a phase value of an object beam of a pth point of the target object.

11. The method of claim 8, wherein if the ratio between the number of the change points and the number of the entire frame points is equal to or greater than the critical value, the hologram information is computed by the following equation,
$${I}_{n} ( x , y ) = {\sum }_{p = 1}^{N} {a}_{p} T ( x - {x}_{p} , y - {y}_{p} ; {z}_{p} )$$
whereas, Iₙ is the hologram information of an n-th frame, aₚ is an intensity value of the object beam of the pth point of the target object, and N is the number of points of the target object.

12. The method of claim 8, wherein if the ratio between the number of the change points and the number of the entire frame points is less than the critical value, the hologram information is computed by the following equation,
$${I}_{n} ( x , y ) = {I}_{n - 1} ( x , y ) - {\sum }_{p = 1}^{{N}_{d}} {a}_{{p}_{n - 1}} {U}_{n - 1} ( x - {x}_{p} , y - {y}_{p} ; {z}_{p} ) + {\sum }_{p = 1}^{{N}_{d}} {a}_{{p}_{n}} {U}_{n} ( x - {x}_{p} , y - {y}_{p} ; {z}_{p} )$$
whereas, Iₙ is the hologram information of an n-th frame, N_{d} is the number of changed points, and Uₙ, is the hologram pattern of change point and 0 at points other than the change point.
